(19) United States
(12) Patent Application Publication
(10) Pub. No.: US 2014/0170609 A1
(43) Pub. Date: Jun. 19, 2014

(54) PERSONALIZED COMPLIANCE FEEDBACK VIA MODEL-DRIVEN SENSOR DATA ASSESSMENT

(71) Applicant: International Business Machines Corporation, Armonk, NY (US)

(72) Inventors: Mark Hsiao, Sindian City (TW); Pei-Yun Sabrina Hsueh, Hawthorne, NY (US); Sreeram Ramakrishnan, Yorktown Heights, NY (US)

(73) Assignee: International Business Machines Corporation, Armonk, NY (US)

(21) Appl. No.: 13/969,722

(22) Filed: Aug. 19, 2013

Related U.S. Application Data
(63) Continuation of application No. 13/715,081, filed on Dec. 14, 2012.

(51) Int. Cl. G09B 19/00

(52) U.S. Cl. CPC G09B 19/00; G09B 19/0092
USPC 434/127; 434/247

(57) ABSTRACT

A method of providing personalized compliance feedback includes detecting user movement data using at least one data sensor, parsing the detected user movement data into segments indicative of potential activity, wherein each segment comprises event motion data occurring during a corresponding time interval, identifying at least one recognized activity from the parsed user movement data, generating feedback based on the at least one recognized activity, and outputting the generated feedback.

### CROSS REFERENCE TO RELATED APPLICATIONS

This application is a Continuation Application of U.S. application Ser. No. 13/715,081, filed on Dec. 14, 2012, the disclosure of which is incorporated by reference herein in its entirety.

### BACKGROUND

1. Technical Field

The present invention relates to personalized compliance feedback via model-driven sensor data assessment, and more particularly, to a system and method of personalized compliance feedback via model-driven sensor data assessment.

2. Discussion of Related Art

The prevalence of lifestyle-related health problems presents a challenge to the national healthcare system. Individual effort helps manage the risks of potential diseases before they develop into more serious health problems. Preventative measures taken by high risk individuals can result in the overall reduction in medical care costs.

Studies demonstrate that individuals who monitor the adherence levels of their daily exercise and food intake typically have more success in avoiding the contraction of many chronic diseases. However, existing self-monitoring systems, which rely on non-interactive, manual self-reporting to generate “one shot,” non-real-time feedback from physicians, fitness experts, etc., may not provide an accurate source of information for a user to measure actual adherence. Manual self-reporting frequently results in a patient having low motivation as the result of getting easily bored of performing the same daily static routines, low compliance due to the lack of incentives for behavior change, and low effectiveness as the result of the patient being unable to monitor his or her activity/exercise status and compliance level.

### BRIEF SUMMARY

According to an exemplary embodiment of the present invention, a method of providing personalized compliance feedback includes detecting user movement data using at least one data sensor, parsing the detected user movement data into segments indicative of potential activity, wherein each segment comprises event motion data occurring during a corresponding time interval, identifying at least one recognized activity from the parsed user movement data, generating feedback based on the at least one recognized activity, and outputting the generated feedback.

The generated feedback may be output in real-time.

The user movement data may be parsed into the segments based on a motion threshold and a time threshold.

Identifying the at least one recognized activity may be based on comparing the segments with predefined activities stored in an activity models database.

The method may further include identifying at least one abnormal event in the user movement data based on a comparison of the at least one recognized activity and the predefined activities.

The method may further include identifying an adherence level based on the at least one abnormal event, wherein the feedback comprises the adherence level.

The method may further include storing the at least one recognized activity in a personal wellness record database.

The method may further include generating a personalized diet plan based on data stored in the personal wellness record database, wherein the feedback comprises the personalized diet plan.

The method may further include generating a personalized exercise plan based on data stored in the personal wellness record database, wherein the feedback comprises the personalized exercise plan.

At least one recognized activity may be identified using a Hidden Markov Model (HMM).

According to an exemplary embodiment of the present invention, a personalized compliance feedback system includes at least one data sensor configured to detect user movement, an event detector component configured to parse the detected user movement data into segments indicative of potential activity, wherein each segment comprises event motion data occurring during a corresponding time interval, an activity analyzer component configured to identify at least one recognized activity from the parsed user movement data, and a real-time monitor component configured to generate feedback based on the at least one recognized activity and output the generated feedback to a display.

The event detector component may be configured to parse the user movement data into the segments based on a motion threshold and a time threshold.

The activity analyzer component may be configured to identify the at least one recognized activity based on comparing the segments with predefined activities stored in an activity models database.

The real-time monitor component may include an abnormal event watcher component configured to identify at least one abnormal event in the user movement data based on a comparison of the at least one recognized activity and the predefined activities.

The abnormal event watcher component may be configured to identify an adherence level based on the at least one abnormal event, wherein the feedback comprises the adherence level.

The system may include a personal wellness record database configured to store the at least one recognized activity.

The system may further include a personalized planner component configured to generate a personalized diet plan based on data stored in the personal wellness record database, wherein the feedback comprises the personalized diet plan, or configured to generate a personalized exercise plan based on data stored in the personal wellness record, wherein the feedback comprises the personalized exercise plan.

The activity analyzer component may be configured to identify the at least one recognized activity using a Hidden Markov Model (HMM).

According to an exemplary embodiment of the present invention, a computer program product for providing personal compliance feedback, the computer program product comprising a computer readable storage medium having program code embodied therewith, the program code executable by a processor, performs a method including detecting user movement data using at least one data sensor, parsing the detected user movement data into segments indicative of potential activity, wherein each segment comprises event motion data occurring during a corresponding time interval, identifying at least one recognized activity from the parsed user movement data, generating feedback based on the at least one recognized activity, and outputting the generated feedback.

### BRIEF DESCRIPTION OF THE SEVERAL VIEWS OF THE DRAWINGS

The above and other features of the present invention will become more apparent by describing in detail exemplary embodiments thereof with reference to the accompanying drawings, in which:

FIG. 1 shows a combined flow chart and software architecture diagram of a personalized compliance feedback system, according to an exemplary embodiment of the present invention.

FIG. 2A shows various components of the data collection and analysis component and corresponding data, according to an exemplary embodiment of the present invention.

FIG. 2B shows segmented user motion data, according to an exemplary embodiment of the present invention.

FIG. 2C shows the utilization of a Hidden Markov Model (HMM) to learn and recognize user activities, according to an exemplary embodiment of the present invention.

FIG. 3 is a flow chart showing a method of creating and using predefined activities, according to an exemplary embodiment of the invention.

FIG. 4 shows an exemplary computer system for performing personalized compliance feedback, according to an exemplary embodiment of the present invention.

### DETAILED DESCRIPTION

Exemplary embodiments of the present invention now will be described more fully hereinafter with reference to the accompanying drawings. This invention, may however, be embodied in many different forms and should not be construed as limited to the embodiments set forth herein.

According to exemplary embodiments, wireless sensors and motion analysis are used to perform intelligent sensing, providing more accurate activity monitoring and recording while a user is exercising. Utilization of real-time monitoring allows for the detection of abnormal events during exercising, and can be used to assist the user in properly performing the exercise according to the analyzed result obtained via intelligent sensing. Exemplary embodiments further provide recommendations regarding the appropriate diet and exercise regimen based on the user's activity level.

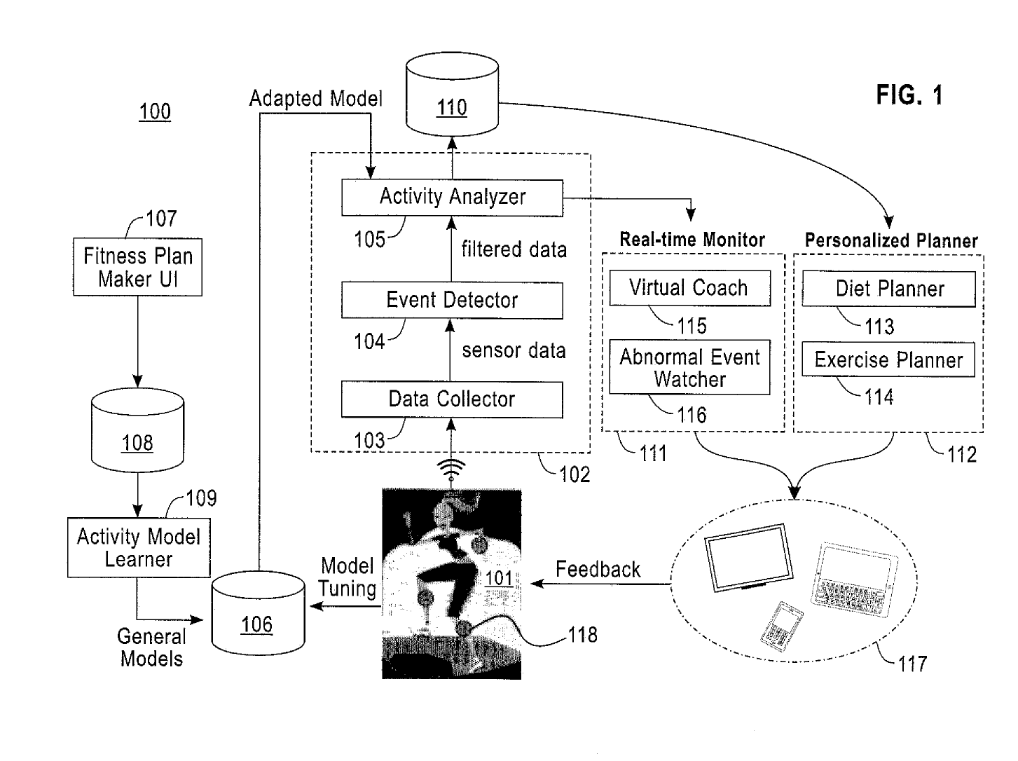

FIG. 1 shows a combined flow chart and software architecture diagram of a personalized compliance feedback system, according to an exemplary embodiment of the present invention.

At block 101, a user is performing exercises. Motion capture technology is utilized to detect and track the user's movements. The motion capture technology may be, for example, a non-optical system using a sensor(s) 118 worn by the user (e.g., wireless inertial sensors) or an optical system using markers, however, the motion capture technology is not limited thereto. For example, any type of motion capture technology capable of detecting and tracking the user's movement may be utilized.

The detected user movement data is transmitted to the data collection and analysis component 102. Although FIG. 1 shows the movement data transmitted wirelessly from wireless sensors 118 worn by the user, exemplary embodiments are not limited thereto. For example, in an exemplary embodiment, the wireless sensors 118 may be connected to a computing device via a wired connection once the user has completed the exercise, and transferred to the data collection and analysis component 102 via the wired connection.

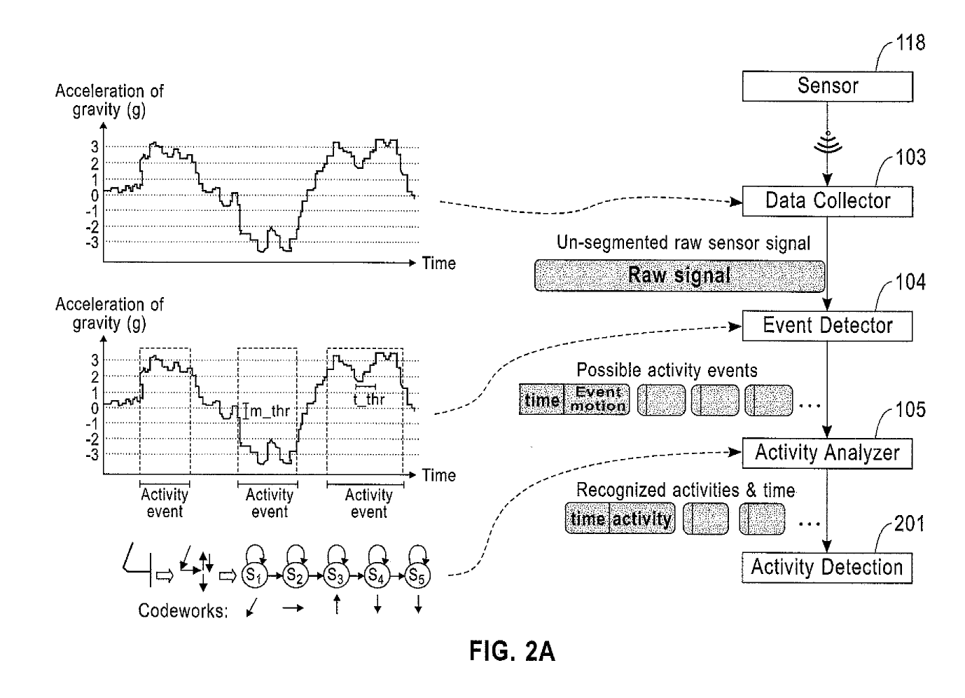

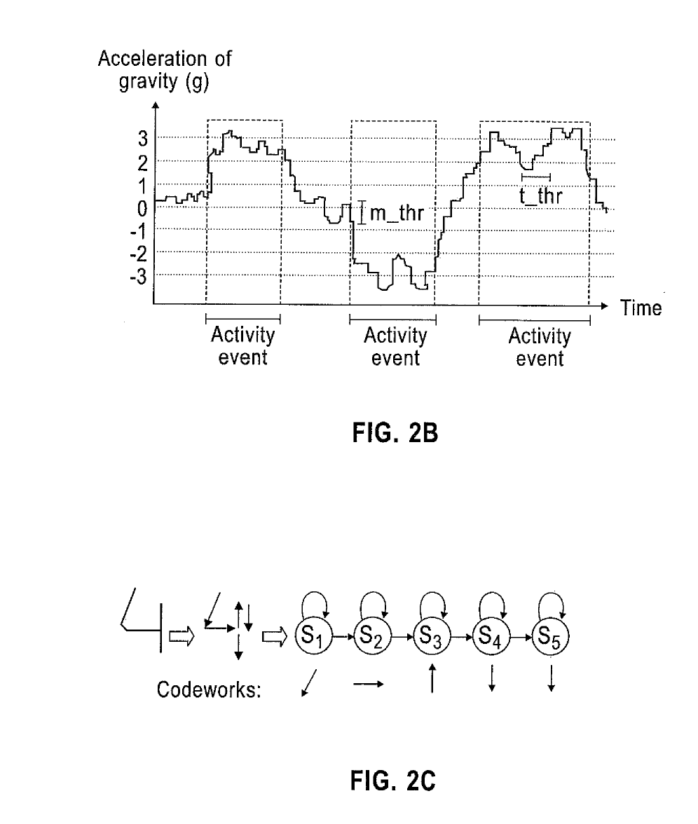

The data collection and analysis component 102 includes a data collector component 103, an event detector component 104, and an activity analyzer component 105, which are described in further detail with reference to FIGS. 2A-2C.

The data collector component 103 receives un-segmented raw data collected by the sensor(s) 118 worn by the user. The raw data may be, for example, the acceleration of gravity over time, as shown in FIG. 2A. The raw data is then transmitted to the event detector component 104.

The event detector component 104 implements a filtering process that identifies time segments during which possible defined activity events have occurred. For example, the event detector component 104 parses the un-segmented raw data into time segments indicative of a potential activity, as shown in FIGS. 2A and 2B. Each piece of segmented data includes event motion data and a corresponding time interval during which the event motion data occurred, as shown in FIG. 2A. A motion threshold m_thr and a time threshold t_thr are applied to all motion vectors, as shown in FIG. 2B. Once the event detector component 104 performs the filtering process on the sensor data, the filtered data is transmitted to the activity analyzer component 105.

The activity analyzer component 105 receives the filtered data from the event detector component 104, analyzes the filtered data, and identifies recognized activities occurring during the segmented times. Recognized activities performed by the user and present in the filtered data may be identified by comparing them with a collection of predefined activities stored in an activity models database 106. The activity models database 106, and the process by which predefined activities are learned and stored in the database 106, are described in further detail below. Activities may be learned and recognized using a Hidden Markov Model (HMM) as shown in FIGS. 2A and 2C, however, learning and recognition of activities is not limited thereto. For example, in an exemplary embodiment, a left-right HMM may be utilized for the learning and recognition of activities, since left-right HMM is effective for modeling order-constrained time-series. An expectation-maximization (EM) algorithm may be used to perform full training for the initialized HMM parameters. As shown in FIG. 2A, the activity analyzer component 105 converts time segments including event motion representing possible activity events to time segments including actual recognized activities.

As shown in FIG. 2A, once the activity analyzer component 105 has analyzed the filtered data to identify recognized activities, activity detection is performed at block 201. This activity detection corresponds to repeating data collection by the data collector component 103, and proceeding through the subsequent processes as described above (e.g., the process described above is repeated as the user performs additional activities and more data is collected).

As described above, the activity models database 106 includes a collection of predefined activities which are used by the activity analyzer component 105 to identify recognized activities performed the user. These predefined activities may be created by a fitness planner (e.g., a physician, a health or exercise specialist, the user, etc.) using a fitness plan maker user interface at block 107. The created activities may be stored in an exercise prescription database 108. For example, the fitness planner defines exercise regimens for a user, and inputs these exercise regimens (e.g., exercise templates) to the exercise prescription database 108 in the form of raw activity motion signals, which are stored in the database 108. The raw activity motion signals may include a time series where each component is a three-dimensional vector. Based on the stored exercise templates, the personalized compliance feedback system 100 can monitor a user's activity compliance.

The activities stored in the database 108 may later be accessed by an activity model learner component 109, and the activity model learner component 109 may then build a model for each activity based on the motion signals stored in the exercise prescription database 108. The activity model learner component 109 may build the models using an HMM as shown in FIG. 2C, however, building the models is not limited thereto. For example, in an exemplary embodiment, a left-right HMM may be utilized to build the models, since left-right HMM is effective for modeling order-constrained time-series. An expectation-maximization (EM) algorithm may be used to perform full training for the initialized HMM parameters. The model learning process includes learning the model coefficients. For example, when HMM is used to build the models, the following formula may be utilized:

λ=( [symbol] ; A; B)

In the above formula, [symbol] , A and B correspond to the initial probabilities, state transition probabilities, and output probabilities, respectively.

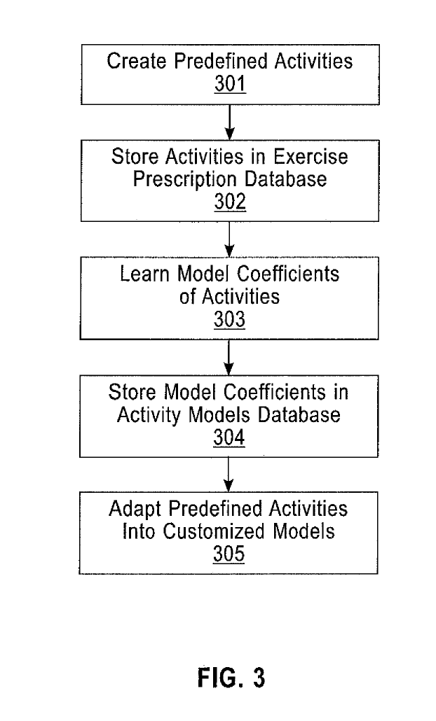

FIG. 3 is a flow chart showing a method of creating and using predefined activities, according to an exemplary embodiment of the present invention.

At block 301, predefined activities are created, e.g., by a fitness planner. At block 302, the activities are stored in the exercise prescription database 108 as raw activity motion signals. At block 303, the activity model learner component 109 learns the model coefficients of the activities (e.g., using HMM). At block 304, the learned model coefficients are stored in the activity models database 106. In an exemplary embodiment, if the user provides additional training data (e.g., additional activity motion signals), the predefined activities may be adapted to a customized model at block 305. For example, since the models stored in the activity models database 106 are general activity models that are not designed for a specific user, there may be a low activity recognition rate for different users who perform the same activities at different speeds, angles, etc. In an exemplary embodiment, during online exercise monitoring, the personalized compliance feedback system 100 may allow a user to perform model tuning, which transforms a general activity model into a personalized activity model. Model tuning may be performed by having a user initially perform several sets of activities for system calibration. The resulting activity motion signals may be collected by the system 100, and a learning method such as, for example, maximum likelihood linear regression (MLRR), may be utilized to adapt the general model into the customized model.

Referring once again to the activity analyzer component 105, once the activity analyzer component 105 has analyzed the filtered data received from the event detector component 104 to identify recognized activities performed by the user, the identified recognized activities are transmitted to a personal wellness record database 110. Storing the activities in the personal wellness record database 110 allows for the creation and maintaining of a diary for the user, recording all of the user's past exercise activities. These records may be used by a personalized planner component 112 to create a personalized diet plan (e.g., by a diet planner component 113) and personalized exercise plans (e.g., by an exercise planner component 114) for the user, as described in further detail below.

The identified recognized activities are also transmitted from the activity analyzer component 105 to a real-time monitor component 111, which includes a virtual coach component 115 and an abnormal event watcher component 116. The abnormal event watcher component 116 analyzes the identified activities and determines an adherence level of the user regarding the exercise activities performed by the user. For example, based on a comparison of the identified activities and the activity models from the activity models database 106, the abnormal event watcher component 116 can identify abnormal events (e.g., abnormal motions) of the user. The virtual coach component 115 can then provide output to a display device 117 that helps guide a user towards a correct exercise performance. That is, using the abnormal event watcher component 116 and the virtual coach component 115, the real-time monitor component 111 can output a recommended appropriate exercise to the user. In addition, based on the user's activity level, the personalized planner component 112 can provide a recommended appropriate diet and a recommended appropriate exercise regimen to the user via the display device 117, as described in more detail below. The display device 117 may be a variety of displays, including, for example, a television, a personal computer, a tablet computer, a smartphone, etc.

Providing feedback and suggestions to the user in real-time creates a personalized adherence feedback loop, which assists the user in initiating and sustaining health behavior change. This real-time adherence feedback loop provides the user with an accurate source of information to measure actual adherence, and may assist in combating low motivation of the user, low compliance regarding the user's exercise adherence and diet adherence, and low effectiveness of the user's health behavior change.

In an exemplary embodiment, the personalized planner component 112 utilizes the monitored activity level of the user to provide an adapted diet plan (e.g., by the diet planner component 113) and an adapted exercise plan (e.g., by the exercise planner component 114) for the user. These adapted plans provide the user with long-term suggestions assisting the user in meeting long-term health goals. For example, the daily nutritional needs of the user are determined based on standard health guidelines and the user's monitored activity level. For example, if the activity level of a user is high on a particular day, the diet planner component 113 may output a notification to the user that the user may increase his or her recommended caloric intake for the day by a certain amount. If the activity level of a user is low on a particular day, the exercise planner component 114 may output a notification to the user suggesting that the user partake in a heavier exercise plan.

The personalized planner component 112 may identify a food combination that matches the user's individual nutritional needs and preference regarding food. Such identification may be performed based on the following equation, which is subject to certain constraints:

max Σ xi*PF(fi)

The nutritional constraint may be expressed as:

$${\sum }_{i = 1}^{n} xi * ei \leq E + thr ( L )$$

In the above equations, xi represents the quantity of an i-th food (e.g., the decision variable), PF(fi) is a score representing the user preference regarding the i-th food, ei is the amount of calories in the i-th food, E is the physician suggested daily caloric consumption, and thr(L) is the extra allowable daily caloric consumption based on the user activity L, which is learned by the personalized compliance feedback system 100, as described above. For example, thr(L) may be equal to about 300 when the user's activity level L is low, 500 when the user's activity level L is moderate, and 800 when the user's activity level L is high.

It is to be understood that exemplary embodiments of the present invention may be implemented in various forms of hardware, software, firmware, special purpose processors, or a combination thereof. In one embodiment, a method for personalized compliance feedback via model-driven sensor data assessment may be implemented in software as an application program tangibly embodied on a computer readable storage medium or computer program product. As such, the application program is embodied on a non-transitory tangible media. The application program may be uploaded to, and executed by, a processor comprising any suitable architecture.

It should further be understood that any of the methods described herein can include an additional step of providing a system comprising distinct software modules embodied on a computer readable storage medium. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

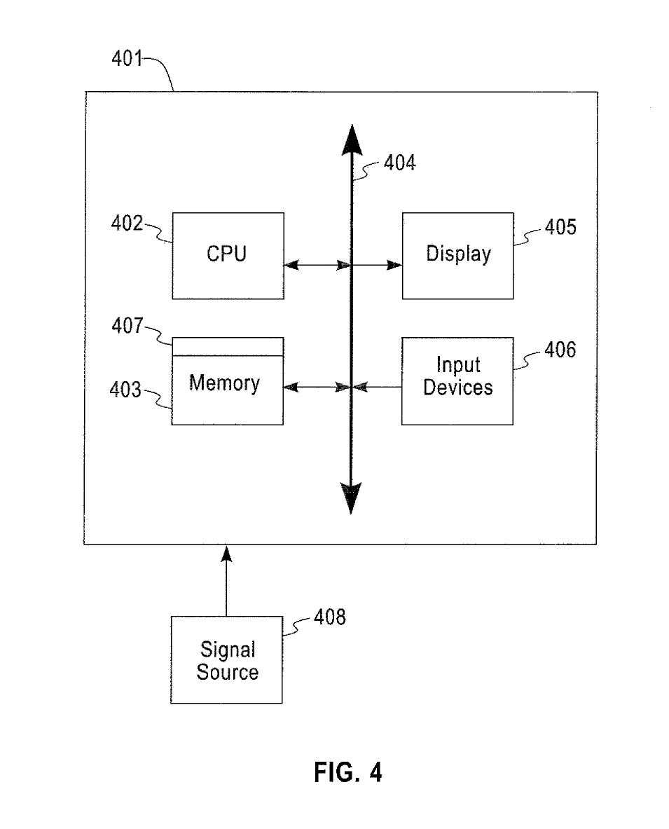

Referring to FIG. 4, according to an exemplary embodiment of the present invention, a computer system 401 for personalized compliance feedback via model-driven sensor data assessment can comprise, inter alia, a central processing unit (CPU) 402, a memory 403 and an input/output (I/O) interface 404. The computer system 401 is generally coupled through the I/O interface 404 to a display 405 and various input devices 406 such as a mouse and keyboard. The support circuits can include circuits such as cache, power supplies, clock circuits, and a communications bus. The memory 403 can include random access memory (RAM), read only memory (ROM), disk drive, tape drive, etc., or a combination thereof. The present invention can be implemented as a routine 407 that is stored in memory 403 and executed by the CPU 402 to process the signal from the signal source 408. As such, the computer system 401 is a general-purpose computer system that becomes a specific purpose computer system when executing the routine 407 of the present invention.

The computer platform 401 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described exemplary embodiments for a system and method for personalized compliance feedback via model-driven sensor data assessment, it is noted that modifications and variations can be made by persons skilled in the art in light of the above teachings. It is therefore to be understood that changes may be made in exemplary embodiments of the invention, which are within the scope and spirit of the invention as defined by the appended claims. Having thus described the invention with the details and particularity required by the patent laws, what is claimed and desired protected by Letters Patent is set forth in the appended claims.

What is claimed is:

1. A personalized compliance feedback system, comprising:
at least one data sensor configured to detect user movement;
an event detector component configured to parse the detected user movement data into segments indicative of potential activity, wherein each segment comprises event motion data occurring during a corresponding time interval;
an activity analyzer component configured to identify at least one recognized activity from the parsed user movement data; and
a real-time monitor component configured to generate feedback based on the at least one recognized activity, and output the generated feedback to a display.

2. The system of claim 1, wherein the generated feedback is output in real-time.

3. The system of claim 1, wherein the event detector component is configured to parse the user movement data into the segments based on a motion threshold and a time threshold.

4. The system of claim 1, wherein the activity analyzer component is configured to identify the at least one recognized activity based on comparing the segments with predefined activities stored in an activity models database.

5. The system of claim 4, wherein the real-time monitor component comprises an abnormal event watcher component configured to identify at least one abnormal event in the user movement data based on a comparison of the at least one recognized activity and the predefined activities.

6. The system of claim 5, wherein the abnormal event watcher component is configured to identify an adherence level based on the at least one abnormal event, wherein the feedback comprises the adherence level.

7. The system of claim 1, further comprising a personal wellness record database configured to store the at least one recognized activity.

8. The system of claim 7, further comprising a personalized planner component configured to generate a personalized diet plan based on data stored in the personal wellness record database, wherein the feedback comprises the personalized diet plan.

9. The system of claim 7, further comprising a personalized planner component configured to generate a personalized exercise plan based on data stored in the personal wellness record, wherein the feedback comprises the personalized exercise plan.

10. The system of claim 1, wherein the activity analyzer component is configured to identify the at least one recognized activity using a Hidden Markov Model (HMM).

11. A computer program product for providing personal compliance feedback, the computer program product comprising a computer readable storage medium having program code embodied therewith, the program code executable by a processor, to perform a method comprising:
detecting user movement data using at least one data sensor;
parsing the detected user movement data into segments indicative of potential activity, wherein each segment comprises event motion data occurring during a corresponding time interval;
identifying at least one recognized activity from the parsed user movement data;
generating feedback based on the at least one recognized activity; and
outputting the generated feedback.

12. The computer program product of claim 11, wherein the user movement data is parsed into the segments based on a motion threshold and a time threshold.

13. The computer program product of claim 11, wherein identifying the at least one recognized activity is based on comparing the segments with predefined activities stored in an activity models database.

14. The computer program product of claim 13, further comprising identifying at least one abnormal event in the user movement data based on a comparison of the at least one recognized activity and the predefined activities.

15. The computer program product of claim 14, further comprising identifying an adherence level based on the at least one abnormal event, wherein the feedback comprises the adherence level.
